(19) United States
(12) Patent Application Publication
(10) Pub. No.: US 2020/0057577 A1
(43) Pub. Date: Feb. 20, 2020

(54) MEMORY SYSTEM AND OPERATING METHOD THEREOF

(71) Applicant: SK hynix Inc., Gyeonggi-do (KR)

(72) Inventor: Eu-Joon BYUN, Gyeonggi-do (KR)

(21) Appl. No.: 16/375,924

(22) Filed: Apr. 5, 2019

(30) Foreign Application Priority Data
Aug. 14, 2018 (KR) 10-2018-0094949

(51) Int. Cl. G06F 3/06

(52) U.S. Cl. CPC G06F 3/0656; G06F 3/0679; G06F 3/0604

(57) ABSTRACT

A memory system includes a memory device including a plurality of open memory blocks; and a controller suitable for controlling the memory device, wherein the controller includes: a physical-to-logical (P2L) buffer suitable for storing P2L map data for the plurality of open memory blocks into a single piece of merged P2L information; and a processor suitable for processing first P2L map data for a first open memory block, among the plurality of open memory blocks, in an ascending order from a lowest index, among indexes associated with the first P2L map data, within the single piece of merged P2L information, and for processing second P2L map data for a second open memory block, among the plurality of open memory blocks, in a descending order from a highest index, among indexes associated with the second P2L map data, within the single piece of merged P2L information.

### CROSS-REFERENCE TO RELATED APPLICATION

The present application claims priority under 35 U.S.C. § 119(a) to Korean Patent Application No. 10-2018-0094949, filed on Aug. 14, 2018, the disclosure of which is incorporated herein by reference in its entirety.

### BACKGROUND

### I. Field

Various embodiments of the present invention generally relate to a memory system. Particularly, the embodiments relate to a memory system capable of efficiently processing map data, and an operating method thereof.

### 2. Description of the Related Art

The computer environment paradigm has shifted towards ubiquitous computing, which enables computing systems to be used anytime and anywhere. As a result, the demand for portable electronic devices, such as mobile phones, digital cameras, and laptop computers have increased rapidly. Those electronic devices generally include a memory system using a memory device as a data storage device. The data storage device may be used as a main memory device or an auxiliary memory device of a portable electronic device.

Since there is no mechanical driving part, a data storage device used as memory device provides advantages, such as excellent stability and durability, high information access speed, and low power consumption. Also, the data storage device can have a higher data access rate and lower power consumption than a hard disk device. Non-limiting examples of the data storage device having such advantages include Universal Serial Bus (USB) memory devices, memory cards of diverse interfaces, Solid-State Drives (SSD) and the like.

### SUMMARY

Various embodiments of the present invention are directed to a memory system capable of efficiently managing map data by merging a space of a memory assigned to a plurality of open memory blocks.

In accordance with an embodiment of the present invention, a memory system may include: a memory device including a plurality of open memory blocks; and a controller suitable for controlling the memory device, wherein the controller includes: a physical-to-logical (P2L) buffer suitable for storing P2L map data for the plurality of open memory blocks into a single piece of merged P2L information; and a processor suitable for processing first P2L map data for a first open memory block, among the plurality of open memory blocks, in an ascending order from a lowest index, among indexes associated with the first P2L map data, within the single piece of merged P2L information, and for processing second P2L map data for a second open memory block, among the plurality of open memory blocks, in a descending order from a highest index, among indexes associated with the second P2L map data, within the single piece of merged P2L information.

In accordance with an embodiment of the present invention, an operating method of a memory system may include: generating a single piece of merged physical-to-logical (P2L) information including P2L map data for the plurality of open memory blocks; processing first physical-to-logical (P2L) map data for a first open memory block, among the plurality of open memory blocks, in an ascending order from a lowest index, among indexes associated with the first P2L map data, within the single piece of merged P2L information; and processing second P2L map data for a second open memory block, among the plurality of open memory blocks, in a descending order from a highest index, among indexes associated with the second P2L map data, within the single piece of merged P2L information.

In accordance with an embodiment of the present invention, a memory system may include: a memory device including a plurality of open memory blocks; and a controller suitable for controlling the memory device, wherein the controller includes: a physical-to-logical (P2L) buffer having a plurality of indices, suitable for storing first P2L map data for a first open memory block, among the plurality of open blocks, and second P2L map data for a second open memory block, among the plurality of open memory blocks; and a processor suitable for storing the first P2L map data in the P2L buffer in a first index order, and storing the second P2L map data in the P2L buffer in a second index order, wherein the first index order includes one of an ascending index order and a descending index order, and the second index order includes the other of the ascending index order and the descending index order.

### BRIEF DESCRIPTION OF THE DRAWINGS

The description herein makes reference to the accompanying drawings wherein like reference numerals refer to like parts throughout the several views, and wherein:

FIG. 1 is a block diagram illustrating a data processing system including a memory system in accordance with an embodiment of the present disclosure;

FIG. 2A is a diagram illustrating a configuration of the memory in accordance with an embodiment of the present disclosure;

FIG. 26 is a diagram illustrating a configuration of the P2L buffer in accordance with an embodiment of the present disclosure;

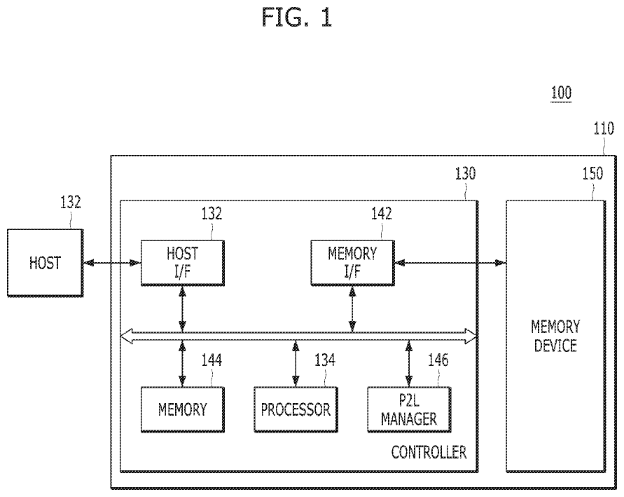

FIG. 3 is a schematic diagram illustrating an exemplary configuration of a memory device of the memory system shown in FIG. 1;

FIG. 4 is a circuit diagram illustrating an exemplary configuration of a memory cell array of a memory block in the memory device shown in FIG. 3;

FIG. 5 is a schematic diagram illustrating an exemplary three-dimensional (3D) structure of the memory device shown in FIG. 3;

FIGS. 6A to 6F are diagrams illustrating an operation of the memory system, including setting an offset value corresponding to unmap data, in accordance with an embodiment of the present disclosure;

FIG. 7 is a flowchart illustrating an operation of the memory system in accordance with an embodiment of the present disclosure;

FIGS. 8 to 16 are diagrams schematically illustrating application examples of a data processing system, in accordance with various embodiments of the present invention.

### DETAILED DESCRIPTION

Various embodiments of the disclosure are described below in more detail with reference to the accompanying drawings. The invention, however, encompasses other embodiments, which may be variations of any of the disclosed embodiments. Thus, the invention is not limited to the embodiments set forth herein. Rather, the described embodiments are provided so that this disclosure is thorough and complete and fully conveys the disclosure to those skilled in the art to which this invention pertains. Throughout the disclosure, like reference numerals refer to like parts throughout the various figures and examples of the disclosure. It is noted that reference to “an embodiment,” “another embodiment” or the like does not necessarily mean only one embodiment, and different references to any such phrase are not necessarily to the same embodiment(s).

It will be understood that, although the terms “first”, “second”, “third”, and so on may be used herein to identify various elements, these elements are not limited by these terms. These terms are used to distinguish one element from another element that otherwise have the same or similar names. Thus, a first element in one instance could also be termed as a second or third element in another instance without departing from the spirit and scope of the present invention.

The drawings are not necessarily to scale and, in some instances, proportions may have been exaggerated in order to clearly illustrate features of the embodiments.

It will be understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present. Communication between two elements, whether directly or indirectly connected/coupled, may be wired or wireless, unless the context indicates otherwise.

The terminology used herein is for the purpose of describing particular embodiments only and is not intended to be limiting of the present invention.

As used herein, singular forms are intended to include the plural forms and vice versa, unless the context clearly indicates otherwise.

It will be further understood that open-ended terms, e.g., “comprises,” “comprising,” “includes,” and “including,” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include, for example, a portable electronic device, such as a mobile phone, an MP3 player and a laptop computer or an electronic device, such as a desktop computer, a game player, a television (TV), a projector and the like.

The memory system 110 may operate or perform a specific function or operation in response to a request from the host 102 and, particularly, may store data to be accessed by the host 102. The memory system 110 may be used as a main memory system or an auxiliary memory system of the host 102. The memory system 110 may be implemented with any one of various types of storage devices, which may be electrically coupled to the host 102, according to a protocol of a host interface. Non-limiting examples of suitable storage devices include a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like.

The storage devices for the memory system 110 may be implemented with any of a variety of volatile memory devices, such as a dynamic random access memory (DRAM) and a static RAM (SRAM) and/or a nonvolatile memory device, such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM or ReRAM) and a flash memory.

The memory system 110 may include a controller 130 and a memory device 150. The memory device 150 may store data to be accessed by the host 102, and the controller 130 may control storage of data in the memory device 150.

The controller 130 and the memory device 150 may be integrated into a single semiconductor device, which may be included in any of the various types of memory systems as exemplified above.

The memory system 110 may be configured as a part of, for example, a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various components configuring a computing system.

The memory device 150 may be a nonvolatile memory device that retains data stored therein even while electrical power is not supplied. The memory device 150 may store data provided from the host 102 through a write operation, and provide data stored therein to the host 102 through a read operation. The memory device 150 may include a plurality of memory blocks, each of the memory blocks may include a plurality of pages. Each of the plurality of pages may include a plurality of memory cells to which a plurality of word lines (WL) are electrically coupled.

The controller 130 may control overall operations of the memory device 150, such as read, write, program and erase operations. For example, the controller 130 may control the memory device 150 in response to a request from the host 102. The controller 130 may provide the data, read from the memory device 150, with the host 102, and/or may store the data, provided by the host 102, into the memory device 150.

The controller 130 may include a host interface (I/F) 132, a processor 134, a memory interface (I/F) 142, a memory 144 and a physical-to-logical (P2L) manager 146, all operatively coupled via an internal bus. Although FIG. 1 exemplifies the memory 144 disposed within the controller 130, the disclosure is not limited thereto. That is, the memory 144 may be located within or externally to the controller 130. For instance, the memory 144 may be embodied by an external volatile memory having a memory interface transferring data and/or signals transferred between the memory 144 and the controller 130.

The host interface 132 may process commands and data provided from the host 102, and may communicate with the host 102 through at least one of various interface protocols, such as universal serial bus (USB), multimedia card (MMC), peripheral component interconnect-express (PCI-e or PCIe), small computer system interface (SCSI), serial-attached SCSI (SAS), serial advanced technology attachment (SATA), parallel advanced technology attachment (PATA), small computer system interface (SCSI), enhanced small disk interface (ESDI) and integrated drive electronics (IDE).

The memory interface 142 may serve as an interface for handling commands and data transferred between the controller 130 and the memory device 150, to allow the controller 130 to control the memory device 150 in response to a request delivered from the host 102. The memory interface 142 may generate a control signal for the memory device 150 and may process data entered into or outputted from the memory device 150 under the control of the processor 134, in a case when the memory device 150 is a flash memory and, in particular, when the memory device 150 is a NAND flash memory.

The memory 144 may serve as a working memory for the memory system 110 and the controller 130, and may store temporary or transactional data for operating or driving the memory system 110 and the controller 130. The controller 130 may control the memory device 150 in response to a request from the host 102. The controller 130 may deliver data read from the memory device 150 into the host 102, may store data entered through the host 102 within the memory device 150. The memory 144 may be used to store data required for the controller 130 and the memory device 150 in order to perform these operations.

The memory 144 may be implemented with a volatile memory, which may be a static random access memory (SRAM) or a dynamic random access memory (DRAM).

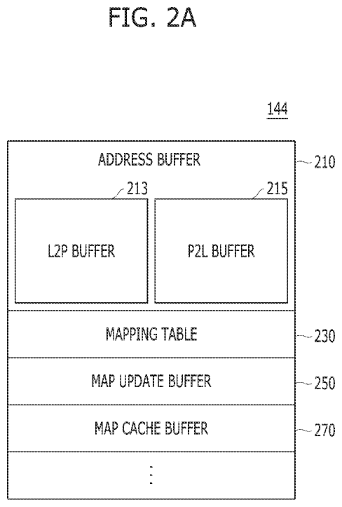

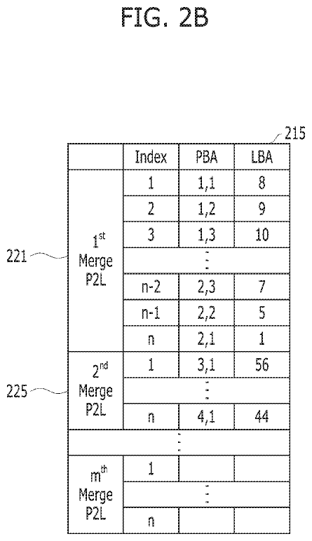

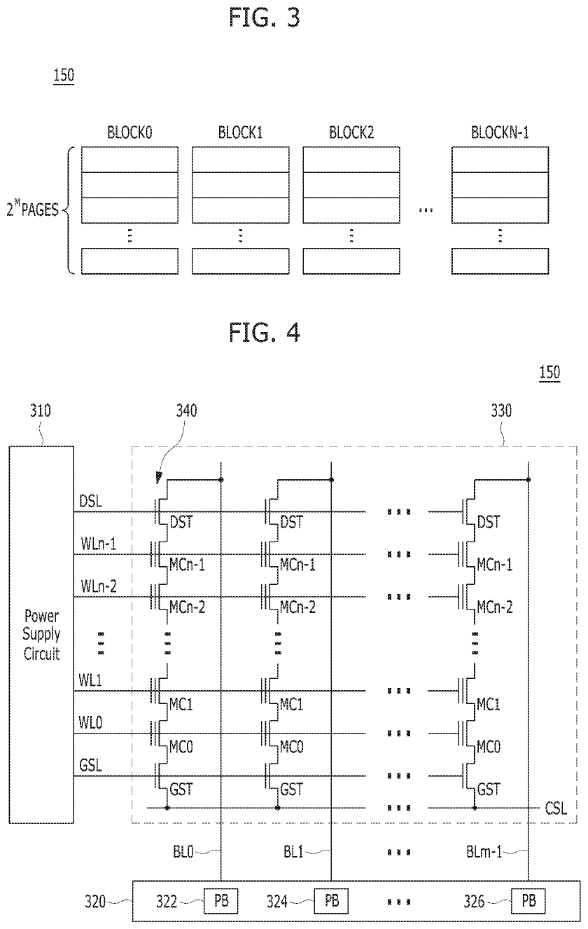

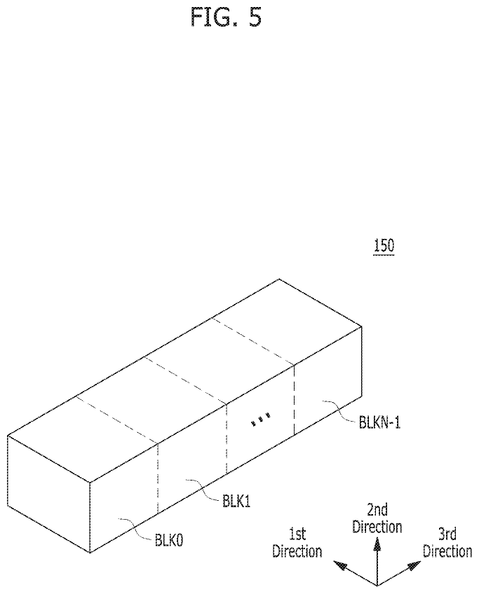

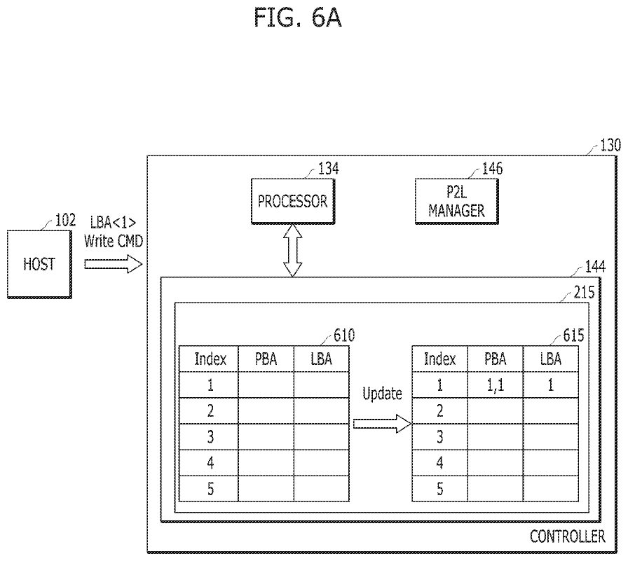

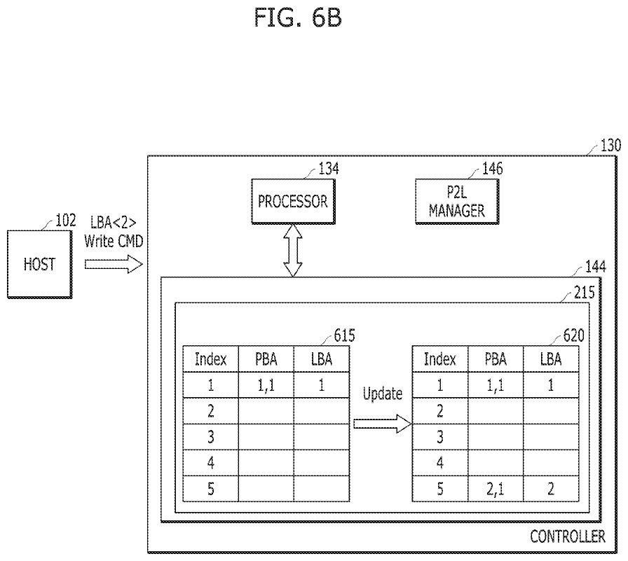

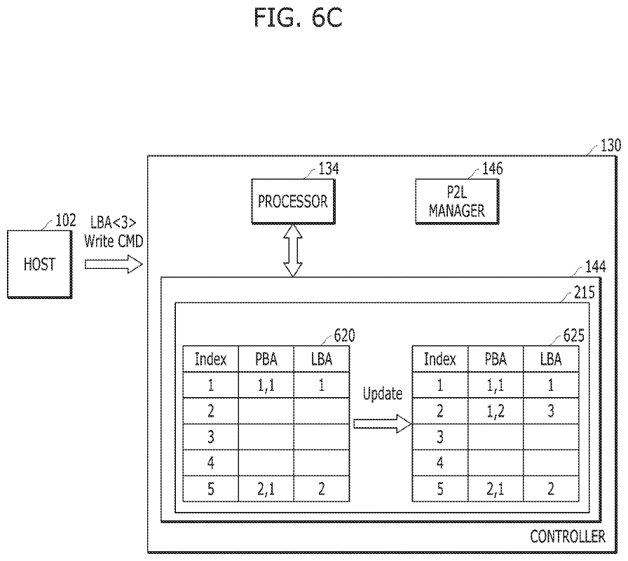

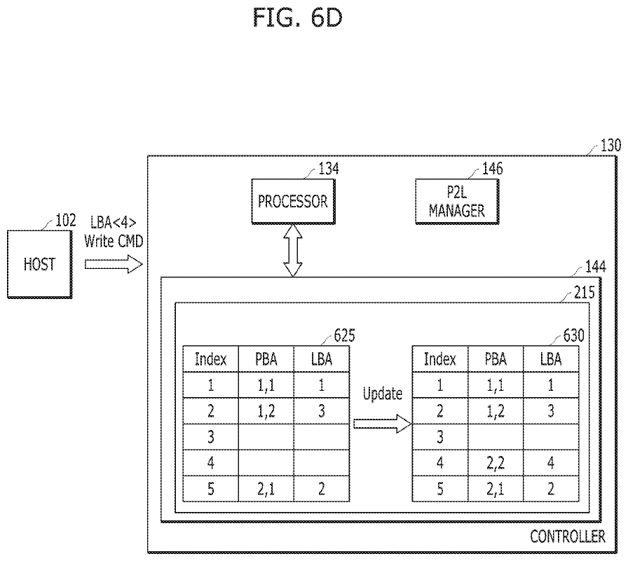

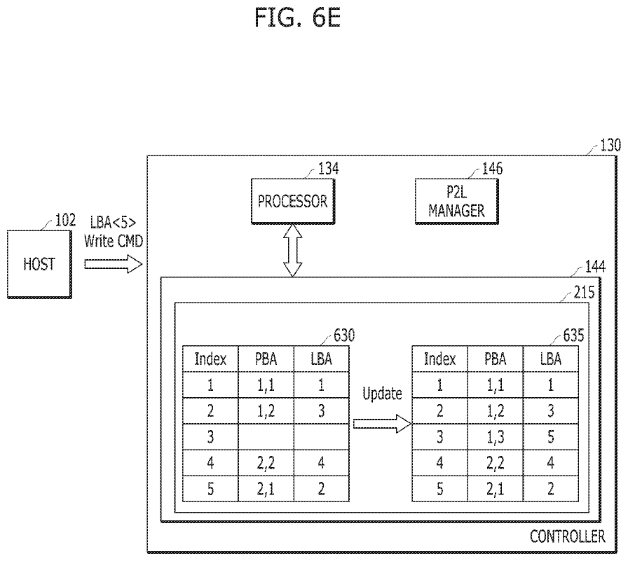

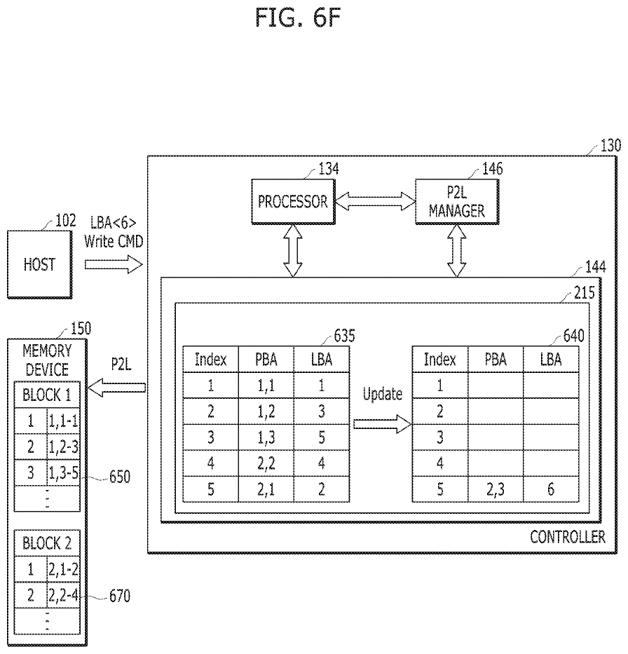

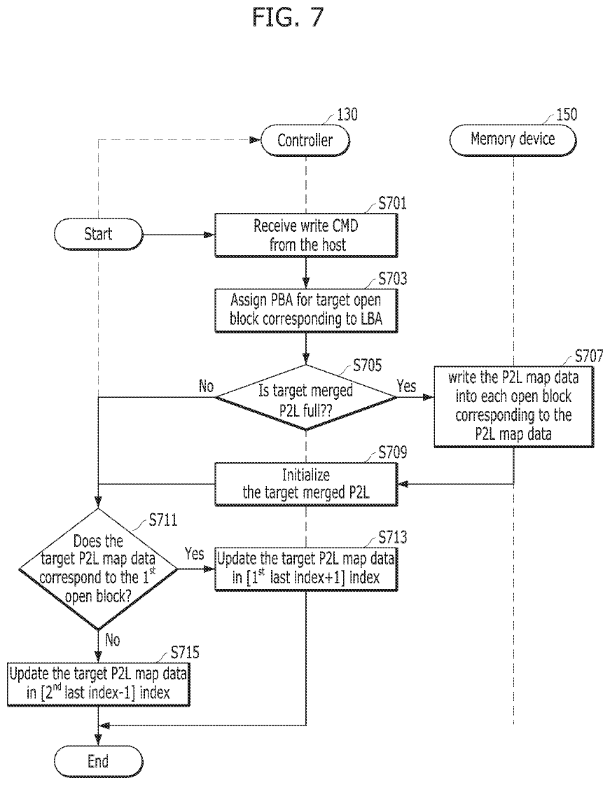

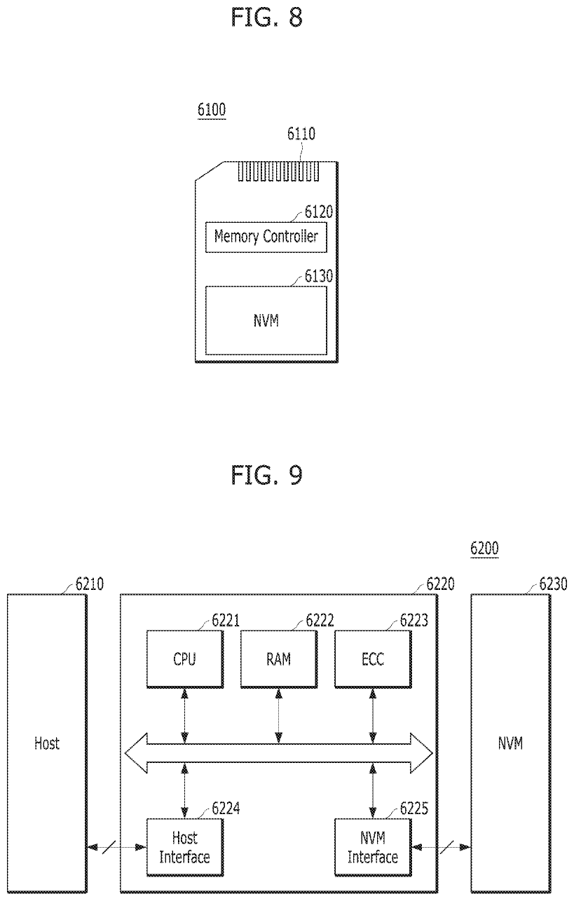

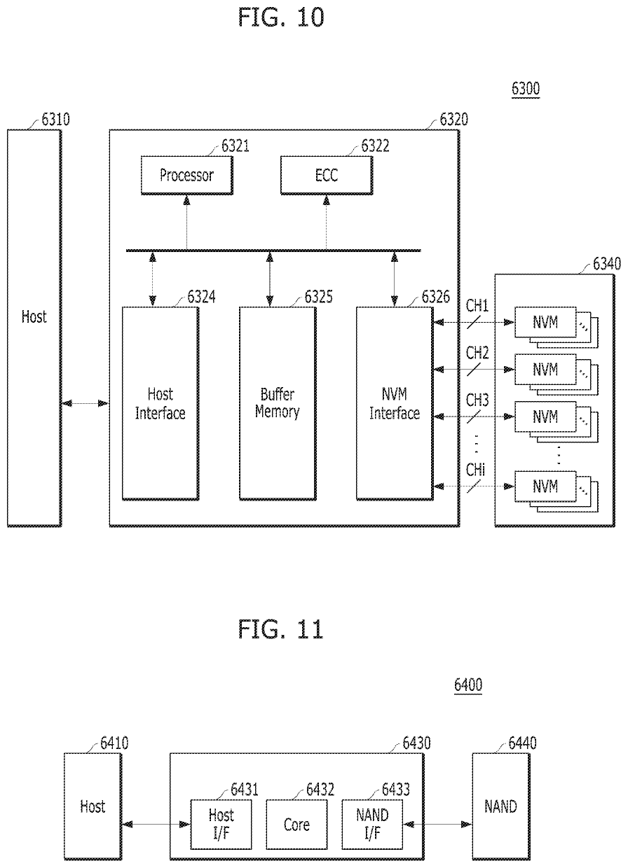

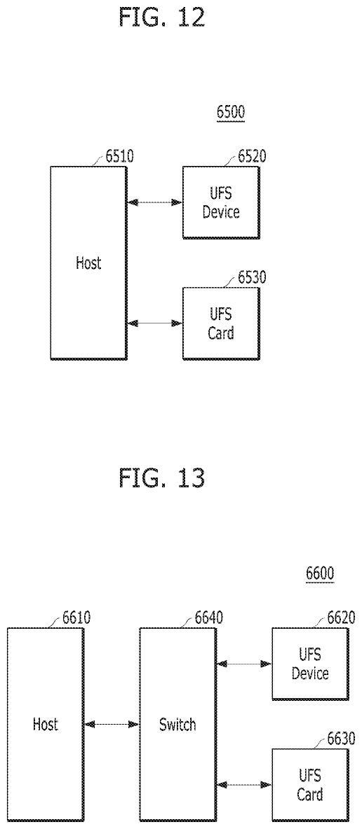

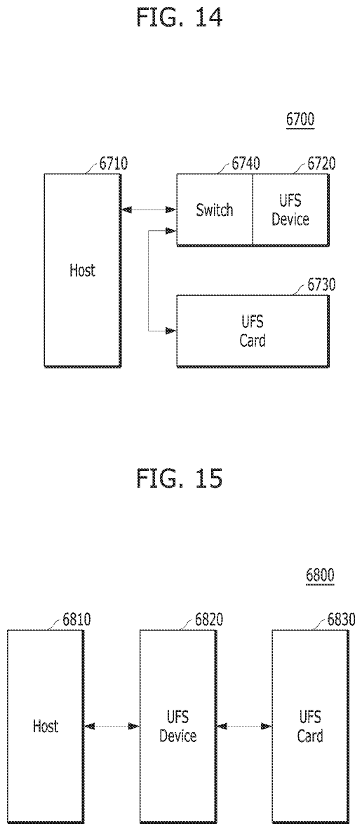

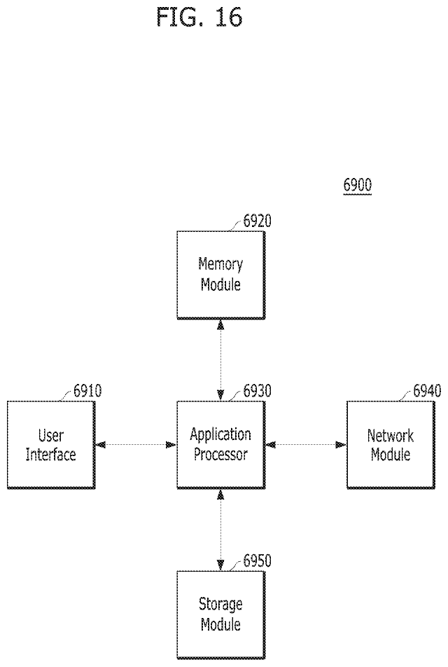

The memory 144 is described below with reference to FIG. 2A in accordance with an embodiment of the present disclosure.

FIG. 2A is a diagram illustrating a configuration of the memory 144 in accordance with an embodiment of the present disclosure.

Referring to FIG. 2A, the memory 144 may include an address buffer 210, a mapping table 230, a map update buffer 250 and a map cache buffer 270.

The address buffer 210 may store map data. Map data may represent a mapping relationship between a logical address LBA provided from the host 102 and a physical address PBA indicating a storage location of data. The map data may be logical-to-physical (L2P) map data or physical-to-logical (P2L) map data. The address buffer 210 may include a L2P buffer 213 and a P2L buffer 215. The L2P buffer 213 may store L2P map data and the P2L buffer 215 may store P2L map data.

When the host 102 provides the controller 130 with a write request, write data may be programmed into storage location(s) indicated by the physical address PBA assigned by the controller 130 rather than by the logical address LBA assigned by the host 102, which is a characteristic of the memory device 150. Therefore, the logical address LBA assigned by the host 102 may be different from the physical address PBA for the write data. The controller 130 may generate the L2P map data to manage information of the logical address LBA corresponding to the physical address PBA, and may store the L2P map data into the L2P buffer 213.

When the requested write data is stored in a particular memory block within the memory device 150, the logical address LBA provided along with the request from the host 102 may be different from the physical address PBA within the particular memory block, as described above. The controller 130 may generate the P2L map data to manage information of the physical address PBA corresponding to the logical address LBA, and may store the P2L map data into the P2L buffer 215.

The P2L map data may be temporarily stored in the address buffer 210 of the memory 144 and may be moved into the memory device 150 at a certain time (e.g., when an open memory block becomes a closed memory block). The controller 130 may control the memory device 150 to perform a background operation, such as a wear-levelling operation and a garbage collection operation by using the P2L map data.

A configuration of the P2L buffer 215 is described below with reference to FIG. 2B.

FIG. 2B is a diagram illustrating a configuration of the P2L buffer 215 in accordance with an embodiment of the present disclosure. In this description, a physical address PBA may be expressed through a corresponding memory block and a corresponding page. For example, a physical address PBA of a first page within a first memory block may be expressed as ‘1, 1’. For example, a physical address PBA expressed as ‘2, 1’ may represent a first page within a second memory block.

The P2L buffer 215 may store plural pieces of merged P2L information, each generated by the processor 134 of FIG. 1. The plural pieces of merged P2L information may each have a set or predetermined size. Each piece of the merged P2L information may include plural pieces of P2L map data, one piece for each of a plurality of open memory blocks. For example, the first merged P2L information 221 may include first P2L map data and second P2L map data for the first open memory block and the second open memory block respectively.

Each piece of the merged P2L information may include first to n-th indexes and first to n-th P2L map data respectively corresponding to the first to n-th indexes. A plurality of open memory blocks represented by one among the plural pieces of merged P2L information may be different from one another. For example, when the first merged P2L information 221 includes first P2L map data and second P2L map data for the first open memory block and the second open memory block respectively, the first open memory block may be different than the second open memory block in terms of their cell configurations, e.g., a single level cell (SLC) memory block or any of several multi-level cell (MLC) memory blocks. SLC and MLC memory blocks are described later with reference to FIGS. 3 to 5.

For example, referring to FIG. 2B, the P2L buffer 215 may store the first merged P2L information 221 to m-th merged P2L information, which are generated by the processor 134 of FIG. 1. The first merged P2L information 221 may include the first P2L map data for the first open memory block and the second P2L map data for the second open memory block. A second merged P2L information 225 may include plural pieces of P2L map data, one piece for each of a third open memory block and a fourth open memory block. However, this configuration is merely an example that does not limit the scope of the present disclosure.

Within the first merged P2L information 221, a first index (1) may correspond to P2L map data representing mapping relationship between an eighth logical address LBA (8) and a physical address PBA indicating a first page of a first open memory block (1,1). Within the first merged P2L information 221, a second index (2) may correspond to P2L map data representing mapping relationship between a ninth logical address LBA (9) and a physical address PBA indicating a second page of the first open memory block (1,2). Within the first merged P2L information 221, a third index (3) may correspond to P2L map data representing mapping relationship between a tenth logical address LBA (10) and a physical address PBA indicating a third page of the first open memory block (1,3). Within the first merged P2L information 221, an n-th index (n) may correspond to P2L map data representing mapping relationship between a first logical address LBA (1) and a physical address PBA indicating a first page of a second open memory block (2,1). Within the first merged P2L information 221, a (n−1)-th index (n−1) may correspond to P2L map data representing mapping relationship between a fifth logical address LBA (5) and a physical address PBA indicating a second page of the second open memory block (2,2). Within the first merged P2L information 221, a (n−2)-th index (n−2) may correspond to P2L map data representing mapping relationship between a seventh logical address LBA (7) and a physical address PBA indicating a third page of the second open memory block (2,3).

As exemplified in FIG. 2B, within the first merged P2L information 221 stored in the P2L buffer 215, the plural pieces of P2L map data for the first open memory block may be arranged in ascending order from the first index. On the other hand, as exemplified in FIG. 2B, within the first merged P2L information 221 stored in the P2L buffer 215, the plural pieces of P2L map data for the second open memory block may be arranged in a descending order from the n-th index.

In the similar manner, as exemplified in FIG. 2B, within the second merged P2L information 225 stored in the P2L buffer 215, the plural pieces of P2L map data for the third open memory block may be arranged in an ascending order from the first index. On the other hand, as exemplified in FIG. 2B, within the second merged P2L information 225 stored in the P2L buffer 215, the plural pieces of P2L map data for the fourth open memory block may be arranged in a descending order from the n-th index.

Referring back to FIG. 2A, the mapping table 230 may have map data stored in the address buffer 210. The mapping table 230 may have a plurality of map segments. Each map segment may have plural pieces of map data.

The map update buffer 250 may temporarily store map data to be updated among plural pieces of map data stored in the memory device 150. The physical address PBA corresponding to each map data temporarily stored in the map update buffer 250 may be changed such that the physical address PBA corresponds to the map data stored in the address buffer 210. The update of the mapping table 230 may be completed as the map data, the physical address PBA of which is changed, is stored in the memory device 150 under the control of the processor 134.

The map cache buffer 270 may cache map data corresponding to a logical address LBA provided along with the recent read request from the host 102 or corresponding to a logical address LBA provided along with the frequent read request from the host 102.

Referring back to FIG. 1, the processor 134 may control overall operation of the memory system 110, and particularly, may control a program operation or a read operation of the memory device 150 in response to a write request or a read request provided from the host 102. The processor 134 may drive firmware, which is often referred to as the “flash translation layer (FTL)”, for the overall control of the memory system 110. The processor 134 may be implemented with a microprocessor or a central processing unit (CPU).

The processor 134 may assign, based on a logical address LBA provided from the host 102, a physical address PBA indicating a storage location of data. The processor 134 may store, in the memory 144, map data representing mapping relationship between the logical address LBA and the physical address PBA.

In accordance with an embodiment of the present invention, the processor 134 may store the P2L map data in the P2L buffer 215.

Referring to FIG. 2B, the processor 134 may assign the first open memory block and the second open memory block of the memory device 150 to the first merged P2L information 221. The processor 134 may store, in the P2L buffer 215, the plural pieces of P2L map data for the first open memory block in an ascending order from the first index (1) within the first merged P2L information 221. The processor 134 may store, in the P2L buffer 215, the plural pieces of P2L map data for the second open memory block in a descending order from the n-th index (n) within the first merged P2L information 221.

When all the indexes are assigned for respective pieces of P2L map data within a single piece of merged P2L information or when one or more among the plurality of open memory blocks become closed memory blocks, the processor 134 may control the memory device 150 to store the P2L map data of the merged P2L information into the corresponding memory blocks. For example, when all the indexes are assigned for respective pieces of P2L map data within the first merged P2L information 221, the processor 134 may control the memory device 150 to store the P2L map data for the first open memory block within the first merged P2L information 221 into the first open memory block and to store the P2L map data for the second open memory block within the first merged P2L information 221 into the second open memory block. For example, when the first open memory block becomes a closed memory block the second open memory block remains open, the processor 134 may control the memory device 150 to store the P2L map data for the first open memory block within the first merged P2L information 221 into the first open memory block and to store the P2L map data for the second open memory block within the first merged P2L information 221 into the second open memory block.

In the above exemplary description, the plural pieces of P2L map data are stored into the respectively corresponding memory blocks. However, in an embodiment, the processor 134 may store the plural pieces of P2L map data into memory blocks other than the respectively corresponding memory blocks.

The P2L manager 146 may manage the P2L map data stored in the P2L buffer 215. Although FIG. 1 exemplifies the P2L manager 146 separately disposed from the processor 134, the P2L manager 146 may be included in the processor 134.

The P2L manager 146 may detect full merged P2L information, which does not have any available entry for additional P2L map data, among the merged P2L information stored in the P2L buffer 215. When full merged P2L information is detected, the P2L manager 146 may request the processor 134 to store the P2L map data of the full merged P2L information into the memory device 150. When the storage of the P2L map data of the full merged P2L information into the memory device 150 is completed in response to the request from the P2L manager 146, the P2L manager 146 may initialize the full merged P2L information for the P2L buffer 215 to have new P2L map data. Then, the processor 134 may generate new P2L map data within the initialized merged P2L information.

The processor 134 may be implemented with a microprocessor or a central processing unit (CPU). The memory system 110 may include one or more processors 134.

A management unit (not shown) may be included in the processor 134. The management unit may perform bad block management of the memory device 150. The management unit may find bad memory blocks in the memory device 150, that is, blocks which are in unsatisfactory condition for further use, and perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. The bad blocks may seriously aggravate the utilization efficiency of the memory device 150 having a 3D stack structure and the reliability of the memory system 100, and thus reliable bad block management is desirable.

The controller 130 may further include an error correction code (ECC) component and a power management unit (PMU).

The ECC component may detect and correct errors in the data read from the memory device 150 during the read operation. When the number of the error bits is greater than or equal to a threshold number of correctable error bits, the ECC component may not correct error bits but instead may output an error correction fail signal indicating failure in correcting the error bits.

The ECC component may perform an error correction operation based on a coded modulation, such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and the like. The ECC component may include all or some of circuits, modules, systems or devices for performing the error correction operation based on at least one of the above described codes.

The PMU may provide and manage power of the controller 130.

FIG. 3 is a schematic diagram illustrating the memory device 150 of FIG. 1.

Referring to FIG. 3, the memory device 150 may include the plurality of memory blocks BLOCK0 to BLOCKN−1. Each of the blocks BLOCK0 to BLOCKN−1 may include a plurality of pages, for example, 2″¹ pages, the number of which may vary according to circuit design. Each of the memory blocks in the memory device 150 may be configured as single level cell (SLC) memory block or a multi-level cell (MLC) memory block, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

FIG. 4 is a circuit diagram illustrating an exemplary memory block 330 in the memory device 150 of FIG. 2.

Referring to FIG. 4, the memory block 330 may correspond to any of the plurality of memory blocks included in the memory device 150 of the memory system 110.

The memory block 330 may include a plurality of cell strings 340 which are electrically coupled to bit lines BL0 to BLm−1, respectively. The cell string 340 of each column may include at least one drain select transistor DST and at least one source select transistor SST. A plurality of memory cells or a plurality of memory cell transistors MC0 to MCn−1 may be electrically coupled in series between the select transistors DST and SST. The respective memory cells MC0 to MCn−1 may be configured by single level cells (SLC) each of which may store 1 bit of information, or by multi-level cells (MLC) each of which may store data information of a plurality of bits. The strings 340 may be electrically coupled to the corresponding bit lines BL0 to BLm−1, respectively. For reference, in FIG. 4, ‘DSL’ denotes a drain select line, ‘SSL’ denotes a source select line, and denotes a common source line.

While FIG. 4 only shows, as an example, that the memory block 330 is constituted with NAND flash memory cells, it is to be noted that the memory block 330 of the memory device 150 according to embodiments is not limited to a NAND flash memory. The memory block 330 may be realized by a NOR flash memory, a hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A power supply circuit 310 of the memory device 150 may provide word line voltages, for example, a program voltage, a read voltage and a pass voltage, to be supplied to respective word lines according to an operation mode and voltages to be supplied to bulks, for example, well regions in which the memory cells are formed. The power supply circuit 310 may perform a voltage generating operation under the control of a control circuit (not shown). The power supply circuit 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read and write (read/write) circuit 320 of the memory device 150 may be controlled by the control circuit, and may serve as a sense amplifier or a write driver according to an operation mode. During a verification operation or a normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs). Each of the page buffers 322 to 326 may include a plurality of latches (not illustrated).

FIG. 5 is a schematic diagram illustrating a three-dimensional (3D) structure of the memory device 150 of FIG. 1.

Although FIG. 5 shows a 3D structure, alternatively the memory device 150 may be embodied by a two-dimensional (2D) or 3D memory device. Specifically, as illustrated in FIG. 5, the memory device 150 may be embodied in a nonvolatile memory device having a 3D stack structure. When the memory device 150 has a 3D structure, the memory device 150 may include a plurality of memory blocks BLK0 to BLKN−1 each having a 3D structure (or a vertical structure).

Operation of the memory system 110 is described below with reference to FIGS. 6A to 6F in accordance with an embodiment of the present disclosure.

FIGS. 6A to 6F are diagrams illustrating examples of an operation of the memory system 110 in accordance with an embodiment of the present disclosure. FIGS. 6A to 6F illustrate P2L map data without illustration of user data. By way of example, and in the context of the description of FIGS. 6A to 6F, the number of indexes of plural pieces of target merged P2L information 610 to 640 is 5, a first target merged P2L information does not have P2L map data, the plural pieces of target merged P2L information 610 to 640 have P2L map data for a first open memory block and a second open memory block, the processor 134 processes the P2L map data for the first open memory block in an ascending order from a first index within the plural pieces of target merged P2L information 610 to 640, and the processor 134 processes the P2L map data for the second open memory block in a descending order from a fifth index within the plural pieces of target merged P2L information 610 to 640.

Referring to FIG. 6A, the host 102 may provide the controller 130 with a first write command corresponding to a first logical address LBA<1>. The processor 134 may assign a first page for a storage location of first write data corresponding to the first write command within the first open memory block. The processor 134 may map the first logical address LBA<1> to a physical address PBA having a value of ‘1, 1’ and may generate first P2L map data for the mapping relationship. The processor 134 may merge the first P2L map data as an entry of the first index (1) into the first target merged P2L information 610 stored in the P2L buffer 215. Then, the first target merged P2L information 610 may be updated to become the second target merged P2L information 615.

Referring to FIG. 6B, the host 102 may provide the controller 130 with a second write command corresponding to a second logical address LBA<2>. The processor 134 may assign a first page for a storage location of second write data corresponding to the second write command within the second open memory block. The processor 134 may map the second logical address LBA<2> to a physical address PBA having a value of ‘2, 1’ and may generate second P2L map data for the mapping relationship. The processor 134 may merge the second P2L map data as an entry of the fifth index (5) into the second target merged P2L information 615 stored in the P2L buffer 215. Then, the second target merged P2L information 615 may be updated to become the third target merged P2L information 620.

Referring to FIG. 6C, the host 102 may provide the controller 130 with a third write command corresponding to a third logical address LBA<3>. The processor 134 may assign a second page for a storage location of third write data corresponding to the third write command within the first open memory block. The processor 134 may map the third logical address LBA<3> to a physical address PBA having a value of ‘1, 2’ and may generate third P2L map data for the mapping relationship. The processor 134 may merge the third P2L map data as an entry of the second index (2) into the third target merged P2L information 620 stored in the P2L buffer 215. Then, the third target merged P2L information 620 may be updated to become the fourth target merged P2L information 625.

Referring to FIG. 6D, the host 102 may provide the controller 130 with a fourth write command corresponding to a fourth logical address LBA<4>. The processor 134 may assign a second page for a storage location of fourth write data corresponding to the fourth write command within the second open memory block. The processor 134 may map the fourth logical address LBA<4> to a physical address PBA having a value of ‘2, 2’ and may generate fourth P2L map data for the mapping relationship. The processor 134 may merge the fourth P2L map data as an entry of the fourth index (4) into the fourth target merged P2L information 625 stored in the P2L buffer 215. Then, the fourth target merged P2L information 625 may be updated to become the fifth target merged P2L information 630.

Referring to FIG. 6E, the host 102 may provide the controller 130 with a fifth write command corresponding to a fifth logical address LBA<5>. The processor 134 may assign a third page for a storage location of fifth write data corresponding to the fifth write command within the first open memory block. The processor 134 may map the fifth logical address LBA<5> to a physical address PBA having a value of ‘1, 3’ and may generate fifth P2L map data for the mapping relationship. The processor 134 may merge the fifth P2L map data as an entry of the third index (3) into the fifth target merged P2L information 630 stored in the P2L buffer 215. Then, the fifth target merged P2L information 630 may be updated to become the sixth target merged P2L information 635.

Referring to FIG. 6F, the host 102 may provide the controller 130 with a sixth write command corresponding to a sixth logical address LBA<6>. The processor 134 may assign a third page for a storage location of sixth write data corresponding to the sixth write command within the second open memory block. The processor 134 may map the sixth logical address LBA<6> to a physical address PBA having a value of ‘2, 3’ and may generate sixth P2L map data for the mapping relationship. The P2L manager 146 may detect the sixth target merged P2L information 635 as full merged P2L information and may request the processor 134 to store the P2L map data included in the sixth target merged P2L information 635 into the memory device 150. Then, the processor 134 may control the memory device 150 to store into the first open memory block 650 the first P2L map data, the third P2L map data and the fifth P2L map data, which correspond to the first open memory block 650. Also, the processor 134 may control the memory device 150 to store into the second open memory block 670 the second P2L map data and the fourth P2L map data, which correspond to the second open memory block 670. After that, the P2L manager 146 may initialize the sixth target merged P2L information 635. Then, the processor 134 may merge the sixth P2L map data as an entry of the fifth index (5) into the initialized sixth target merged P2L information 635 stored in the P2L buffer 215. Then, the sixth target merged P2L information 635 may be updated to become the seventh target merged P2L information 640.

FIG. 7 is a flowchart illustrating an operation of the memory system 110 including the controller 130 and the memory device 150 in accordance with an embodiment of the present disclosure. FIG. 7 illustrates an operation related to P2L map data without illustration of user data. By way of example, and in the context of the description of FIG. 7, plural pieces of target merged P2L information have P2L map data for a first open memory block and a second open memory block, the processor 134 may store the P2L map data for the first open memory block in an ascending order from the first index within the plural pieces of target merged P2L information, and the processor 134 may store the P2L map data for the second open memory block in a descending order from the last index within the plural pieces of target merged P2L information. The operation of FIG. 7 may be performed by the controller 130.

Referring to FIG. 7, at step S701, the controller 130 may receive a write command provided from the host 102.

At step S703, the processor 134 may assign a physical address PBA indicating a storage location of write data corresponding to the write command within a target open memory block such that the physical address PBA is mapped to a logical address LBA corresponding to the write command. As a result, the processor 134 may generate target P2L map data.

At step S705, the P2L manager 146 may determine whether target merged P2L information is full merged P2L information, i.e., whether the target merged P2L information is full of P2L map data. The target merged P2L information may indicate a storage location into which the target P2L map data is to be stored.

When it is determined that the target merged P2L information is full merged P2L information (“Yes” at step S705), the memory device 150 may store the P2L map data included in the full merged P2L information into open memory blocks respectively corresponding to the plural pieces of P2L map data in the full merged P2L information at step S707. The P2L manager 146 may detect the target merged P2L information as the full merged P2L information and may request the processor 134 to store the P2L map data included in the target merged P2L information 635 into the memory device 150. Then, the processor 134 may control the memory device 150 to store the P2L map data in the full merged P2L information into open memory blocks respectively corresponding to the plural pieces of P2L map data in the full merged P2L information.

At step S709, the P2L manager 146 may initialize the target merged P2L information. At steps S711 to S713, the processor 134 may merge the target P2L map data into the initialized target merged P2L information stored in the P2L buffer 215.

When it is determined that the target merged P2L information is not full merged P2L information (“No” at step S705), the processor 134 may merge the target P2L map data into the target merged P2L information stored in the P2L buffer 215 at steps S711 to S713.

At step S711, the processor 134 may detect the target merged P2L information for the target P2L map data. For example, the processor 134 may determine whether the target P2L map data corresponds to the first open memory block.

When it is determined that the target P2L map data corresponds to the first open memory block (“Yes” at step S711), at step S713, the processor 134 may merge the target P2L map data as an entry of (a value of “a first-last index+1”)th index into the target merged P2L information. The first-last index may be a last index corresponding to a last entry of P2L map data, which corresponds to the first open memory block and is merged within the target merged P2L information. For example, when previous P2L map data for the first open memory block is merged as an entry of a second index within the target merged P2L information before the target P2L map data is merged within the target merged P2L information, the first-last index may be ‘2’. When the target merged P2L information is initialized, the first-last index may become ‘0’.

When it is determined that the target P2L map data does not correspond to the first open memory block (“No” at step S711), that is, when the target P2L map data corresponds to the second open memory block, at step S715, the processor 134 may merge the target P2L map data as an entry of (a value of a second-last index−1)th index into the target merged P2L information. The second-last index may be a last index corresponding to a last entry of P2L map data, which corresponds to the second open memory block and is merged within the target merged P2L information. For example, when previous P2L map data for the second open memory block is merged as an entry of a fourth index within the target merged P2L information before the target P2L map data is merged within the target merged P2L information, the second-last index may be ‘4’. When the target merged P2L information is initialized, the second-last index may become ‘0’.

In accordance with an embodiment of the present invention, the memory system 110 may efficiently utilize memory space assigned for plural pieces of P2L map data for each of a plurality of memory blocks within the memory 144 by merging the plural pieces of P2L map data.

A data processing system and electronic devices, which may be implemented with the memory system 110 including the memory device 150 and the controller 130 described with reference to FIGS. 1 to 7, are described below in detail with reference to FIGS. 8 to 16.

FIGS. 8 to 16 are diagrams schematically illustrating application examples of the data processing system of FIGS. 1 to 7 according to various embodiments.

FIG. 8 is a diagram schematically illustrating an example of the data processing system including the memory system. FIG. 8 schematically illustrates a memory card system 6100 including the memory system in accordance with an embodiment.

Referring to FIG. 8, the memory card system 6100 may include a memory controller 6120, a memory device 6130 and a connector 6110.

More specifically, the memory controller 6120 may be connected to the memory device 6130, and may be configured to access the memory device 6130. The memory device 6130 may be embodied by a nonvolatile memory (NVM). By the way of example but not limitation, the memory controller 6120 may be configured to control read, write, erase and background operations onto the memory device 6130. The memory controller 6120 may be configured to provide an interface between the memory device 6130 and a host (not shown) and/or drive firmware for controlling the memory device 6130. That is, the memory controller 6120 may correspond to the controller 130 in the memory system 110 described with reference to FIGS. 1 to 7, while the memory device 6130 may correspond to the memory device 150 described with reference to FIGS. 1 to 7.

Thus, as shown in FIG. 1, the memory controller 6120 may include a random access memory (RAM), a processor, a host interface, a memory interface and an error correction code component. The memory controller 6120 may further include the elements described in FIG. 1.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols, such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), wireless fidelity (Wi-Fi or WiFi) and Bluetooth. Thus, the memory system and the data processing system in accordance with an embodiment may be applied to wired and/or wireless electronic devices, particularly mobile electronic devices.

The memory device 6130 may be implemented by a nonvolatile memory (NVM). For example, the memory device 6130 may be implemented by any of various nonvolatile memory devices, such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM). The memory device 6130 may include a plurality of dies as in the memory device 150 of FIG. 1.

The memory controller 6120 and the memory device 6130 may be integrated into a single semiconductor device. For example, the memory controller 6120 and the memory device 6130 may be so integrated to construct a solid state driver (SSD). Also, the memory controller 6120 and the memory device 6130 may construct a memory card, such as a PC card (e.g., Personal Computer Memory Card International Association (PCMCIA)), a compact flash (CF) card, a smart media card (e.g., SM and SMC), a memory stick, a multimedia card (e.g., MMC, RS-MMC, MMCmicro and eMMC), a secured digital (SD) card (e.g., SD, miniSD, microSD and SDHC) and a universal flash storage (UFS).

FIG. 9 is a diagram schematically illustrating another example of a data processing system 6200 including a memory system, in accordance with an embodiment.

Referring to FIG. 9, the data processing system 6200 may include a memory device 6230 having one or more nonvolatile memories (NVMs) and a memory controller 6220 for controlling the memory device 6230. The data processing system 6200 may serve as a storage medium such as a memory card (CF, SD, micro-SD or the like) or USB device, as described with reference to FIG. 1, The memory device 6230 may correspond to the memory device 150 in the memory system 110 described in FIGS. 1 to 7, and the memory controller 6220 may correspond to the controller 130 in the memory system 110 described in FIGS. 1 to 7.

The memory controller 6220 may control a read, write, or erase operation on the memory device 6230 in response to a request of the host 6210, and the memory controller 6220 may include one or more central processing units (CPUs) 6221, a buffer memory such as a random access memory (RAM) 6222, an error correction code (ECC) circuit 6223, a host interface 6224 and a memory interface such as an NVM interface 6225.

The CPU 6221 may control the operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the memory device 6230 to operate at high speed.

The ECC circuit 6223 may correspond to the ECC component 138 of the controller 130 illustrated in FIG. 1. As described with reference to FIG. 1, the ECC circuit 6223 may generate an error correction code (ECC) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. In this case, the ECC circuit 6223 may correct an error using the parity bit. For example, as described with reference to FIG. 1, the ECC circuit 6223 may correct an error using Low Density Parity Check (LDPC) code, Bose-Chaudhri-Hocquenghem (BCH) code, turbo code, Reed-Solomon code, convolution code, Recursive Systematic Code (RSC) or coded modulation such as Trellis-Coded Modulation (TCM) or Block coded modulation (BCM).

The memory controller 6220 may exchange data or signals with the host 6210 through the host interface 6224, and may exchange data or signals with the memory device 6230 through the NVM interface 6225. The host interface 6224 may be connected to the host 6210 through a parallel advanced technology attachment (PATA) bus, a serial advanced technology attachment (SATA) bus, a small computer system interface (SCSI), an universal serial bus (USB), a peripheral component interconnect-express (PCIe), or a NAND interface. The memory controller 6220 may have a wireless communication function with a mobile communication protocol such as wireless fidelity (WiFi) or Long Term Evolution (LTE). The memory controller 6220 may be connected to an external device, e.g., the host 6210, or another external device, and then exchange data with the external device. As the memory controller 6220 is configured to communicate with the external device through one or more of various communication protocols, the memory system and the data processing system in accordance with an embodiment may be applied to wired and/or wireless electronic devices, particularly a mobile electronic device.

FIG. 10 is a diagram schematically illustrating another example of the data processing system including the memory system. FIG. 10 schematically illustrates a solid state drive (SSD) 6300 to which the memory system, in accordance with an embodiment, is applied.

Referring to FIG. 10, the SSD 6300 may include a controller 6320 and a memory device 6340 including a plurality of nonvolatile memories (NVMs). The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, an error correction code (ECC) circuit 6322, a host interface 6324, a buffer memory 6325 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by any of a variety of volatile memories, such as a dynamic random access memory (DRAM), a synchronous DRAM (SDRAM), a double data rate (DDR) SDRAM, a low power DDR (LPDDR) SDRAM and a graphics RAM (GRAM), or by any of a variety of nonvolatile memories, such as a ferroelectric RAM (FRAM), a resistive RAM (RRAM or ReRAM), a spin-transfer torque magnetic RAM (STT-MRAM) and a phase-change RAM (PRAM). By way of example, FIG. 10 illustrates that the buffer memory 6325 is disposed in the controller 6320, but the buffer memory 6325 may be external to the controller 6320.

The ECC circuit 6322 may calculate an error correction code (ECC) value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, a redundant array of independent disks (RAID) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, i.e., RAID level information of the write command provided from the host 6310 in the SSDs 6300, and may output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 11 is a diagram schematically illustrating another example of the data processing system including the memory system. FIG. 11 schematically illustrates an embedded Multi-Media Card (eMMC) 6400 to which the memory system, in accordance with an embodiment, is applied.

Referring to FIG. 11, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface (I/F) 6431 and a memory interface, for example, a NAND interface (I/F) 6433.

The core 6432 may control the operations of the eMMC 6400, the host interface 6431 may provide an interface function between the controller 6430 and the host 6410. The NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, Ultra High Speed (UHS)-I and UHS-II interface.

FIGS. 12 to 15 are diagrams schematically illustrating other examples of the data processing system including the memory system. FIGS. 12 to 15 schematically illustrate universal flash storage (UFS) systems 6500, 6600, 6700 and 6800, to which the memory system, in accordance with an embodiment, is applied.

Referring to FIGS. 12 to 15, the UFS systems 6500, 6600, 6700 and 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired and/or wireless electronic devices or particularly mobile electronic devices, the UFS devices 6520, 6620, 6720, 6820 may serve as embedded UFS devices. The UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700 and 6800 may communicate with external devices, e.g., wired and/or wireless electronic devices or particularly mobile electronic devices through UFS protocols. The UFS devices 6520, 6620, 6720, 6820 and the UFS cards 6530, 6630, 6730, 6830 may be embodied by the memory system 110 illustrated in FIG. 1. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 9 to 11, and the UFS cards 6530, 6630, 6730, 6830 may be embodied in the form of the memory card system 6100 described with reference to FIG. 8.

Furthermore, in the UFS systems 6500, 6600, 6700 and 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through various protocols other than the UFS protocol, e.g., universal storage bus (USB) Flash Drives (UFDs), multi-media card (MMC), secure digital (SD), mini-SD, and micro-SD.

In the UFS system 6500 illustrated in FIG. 12, each of the host 6510, the UFS device 6520 and the UFS card 6530 may include UniPro. The host 6510 may perform a switching operation to communicate with at least one of the UFS device 6520 and the UFS card 6530. The host 6510 may communicate with the UFS device 6520 or the UFS card 6530 through link layer switching, e.g., L3 switching at the UniPro. In this case, the UFS device 6520 and the UFS card 6530 may communicate with each other through a link layer switching at the UniPro of the host 6510. As an example, the configuration in which one UFS device 6520 and one UFS card 6530 are connected to the host 6510 is shown in FIG. 12. However, a plurality of UFS devices and UFS cards may be connected in parallel or in the form of a star to the host 6510, and a plurality of UFS cards may be connected in parallel or in the form of a star to the UFS device 6520 or connected in series or in the form of a chain to the UFS device 6520. Herein, the form of a star means an arrangement in which a single device is coupled with plural other devices or cards for centralized control.

In the UFS system 6600 illustrated in FIG. 13, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. As an example, the configuration in which one UFS device 6620 and one UFS card 6630 are connected to the switching module 6640 is shown in FIG. 13. However, a plurality of UFS devices and UFS cards may be connected in parallel or in the form of a star to the switching module 6640, and a plurality of UFS cards may be connected in series or in the form of a chain to the UFS device 6620.

In the UFS system 6700 illustrated in FIG. 14, each of the host 6710, the UFS device 6720 and the UFS card 6730 may include UniPro. The host 6710 may communicate with the UFS device 6720 or the UFS card 6730 through a switching module 6740 performing a switching operation, for example, the switching module 6740 which performs link layer switching at the UniPro, for example, L3 switching. In this case, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. As an example, the configuration in which one UFS device 6720 and one UFS card 6730 are connected to the switching module 6740 is shown in FIG. 14. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 15, each of the host 6810, the UFS device 6820 and the UFS card 6830 may include M-PHY and UniPro. The UFS device 6820 may perform a switching operation to communicate with the host 6810 and the UFS card 6830. The UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target Identifier (ID) switching operation. Here, the host 6810 and the UFS card 6830 may communicate with each other through target ID switching between the M-PHY and UniPro modules of the UFS device 6820. In the embodiment of FIG. 15, the configuration in which one UFS device 6820 is connected to the host 6810 and one UFS card 6830 is connected to the UFS device 6820 is shown. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

FIG. 16 is a diagram schematically illustrating another example of the data processing system including the memory system. FIG. 16 is a diagram schematically illustrating a user system 6900 to which the memory system, in accordance with an embodiment, is applied.

Referring to FIG. 16, the user system 6900 may include a user interface 6910, a memory module 6920, an application processor 6930, a network module 6940, and a storage module 6950.

More specifically, the application processor 6930 may drive components included in the user system 6900, for example, an operating system (OS), and include controllers, interfaces and a graphic engine which control the components included in the user system 6900. The application processor 6930 may be provided as a System-on-Chip (SoC).

The memory module 6920 may be used as a main memory, work memory, buffer memory or cache memory of the user system 6900. The memory module 6920 may include a volatile random access memory (RAM), such as a dynamic RAM (DRAM), a synchronous DRAM (SDRAM), a double data rate (DDR) SDRAM, DDR2 SDRAM, DDR3 SDRAM, LPDDR SDARM, LPDDR3 SDRAM or LPDDR3 SDRAM or a nonvolatile RAM, such as a phase-change RAM (PRAM), a resistive RAM (ReRAM), a magneto-resistive RAM (MRAM) or a ferroelectric RAM (FRAM). For example, the application processor 6930 and the memory module 6920 may be packaged and mounted, based on Package on Package (PoP).

The network module 6940 may communicate with external devices. For example, the network module 6940 may not only support wired communication, but may also support various wireless communication protocols, such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 10 to 15.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control the operations of the mobile electronic device, and the network module 6940 may serve as a communication module for controlling wired and/or wireless communication with an external device. The user interface 6910 may display data processed by the processor 6930 on a display and touch module of the mobile electronic device, or support a function of receiving data from the touch panel.

While the present invention has been illustrated and described with respect to specific embodiments, it will be apparent to those skilled in the art in light of the present disclosure that various changes and modifications may be made without departing from the spirit and scope of the invention as determined in the following claims.

What is claimed is:

1. A memory system comprising:
a memory device including a plurality of open memory blocks; and
a controller suitable for controlling the memory device,
wherein the controller includes:
a physical-to-logical (P2L) buffer suitable for storing P2L map data for the plurality of open memory blocks into a single piece of merged P2L information; and
a processor suitable for processing first P2L map data for a first open memory block, among the plurality of open memory blocks, in an ascending order from a lowest index, among indexes associated with the first P2L map data, within the single piece of merged P2L information, and for processing second P2L map data for a second open memory block, among the plurality of open memory blocks, in a descending order from a highest index, among indexes associated with the second P2L map data, within the single piece of merged P2L information.

2. The memory system of claim 1, wherein the controller further includes a P2L manager suitable for determining whether the single piece of merged P2L information is full of the P2L map data.

3. The memory system of claim 2, wherein the P2L manager transmits, to the processor, when the single piece of merged P2L information is full of the P2L map data, a request to store the P2L map data included in the single piece of merged P2L information into the memory device.

4. The memory system of claim 3, wherein the processor further controls, in response to the request of the P2L manager, the memory device to store therein the P2L map data included in the single piece of merged P2L information.

5. The memory system of claim 4, wherein the P2L manager initializes the single piece of merged P2L information.

6. The memory system of claim 1, wherein the first open memory block includes a single level cell (SLC) memory block and the second open memory block includes a multiple level cell (XLC) memory block.

7. The memory system of claim 1, wherein the first open memory block includes a multiple level cell (XLC) memory block and the second open memory block includes a single level cell (SLC) memory block.

8. The memory system of claim 1, wherein the processor generates the P2L map data based on a logical address provided from an external source.

9. The memory system of claim 1, wherein the P2L buffer stores the P2L map data for the first and second open memory blocks merged into the single piece of merged P2L information.

10. The memory system of claim 1, wherein the controller further includes a memory including the P2L buffer.

11. An operating method of a memory system comprising a memory device including a plurality of open memory blocks and a controller suitable for controlling the memory device, the operating method comprising:
generating a single piece of merged physical-to-logical (P2L) information including P2L map data for the plurality of open memory blocks;
processing first physical-to-logical (P2L) map data for a first open memory block, among the plurality of open memory blocks, in an ascending order from a lowest index, among indexes associated with the first P2L map data, within the single piece of merged P2L information; and
processing second P2L map data for a second open memory block, among the plurality of open memory blocks, in a descending order from a highest index, among indexes associated with the second P2L map data, within the single piece of merged P2L information.

12. The operating method of claim 11, further comprising determining whether the single piece of merged P2L information is full of the P2L map data.

13. The operating method of claim 12, further comprising storing, when the single piece of merged P2L information is full of the P2L map data, the P2L map data included in the single piece of merged P2L information into the memory device.

14. The operating method of claim 13, further comprising initializing the single piece of merged P2L information.

15. The operating method of claim 11, wherein the first open memory block includes a single level cell (SLC) memory block and the second open memory block includes a multiple level cell (XLC) memory block.

16. The operating method of claim 11, wherein the first open memory block includes a multiple level cell (XLC) memory block and the second open memory block includes a single level cell (SLC) memory block.

17. The operating method of claim 11, further comprising generating the P2L map data based on a logical address provided from an external source.

18. The operating method of claim 11, wherein the generating the single piece of merged P2L information includes generating the single piece of merged P2L information including the P2L map data for the first and second open memory blocks.
